(19) United States
(12) Patent Application Publication
(10) Pub. No.: US 2025/0276518 A1
(43) Pub. Date: Sep. 4, 2025

(54) LIQUID EJECTING HEAD

(71) Applicant: BROTHER KOGYO KABUSHIKI KAISHA, Nagoya (JP)

(72) Inventors: TAISUKE MIZUNO, Yokkaichi (JP); SYOTA FUKUMOTO, Nagoya (JP)

(21) Appl. No.: 19/040,232

(22) Filed: Jan. 29, 2025

(30) Foreign Application Priority Data
Mar. 4, 2024 (JP) 2024-032167
Mar. 4, 2024 (JP) 2024-032169

(51) Int. Cl. B41J 2/14

(52) U.S. Cl. CPC B41J 2/14048; B41J 2202/15

(57) ABSTRACT

A liquid ejecting head includes a channel member having: a common channel extending in a first direction orthogonal to an up-down direction; and individual channels. Individual channel rows each including the individual channels aligned in the first direction are disposed side by side in a second direction orthogonal to the up-down direction and the first direction. A first pressure chamber and a second pressure chamber overlap in the second direction. A first nozzle included in the first individual channel row and a second nozzle included in the second individual channel row are located on one side in the second direction with respect to the common channel. The first nozzle is located closer to the common channel than the second nozzle is in the second direction, and the first nozzle overlaps with the second pressure chamber in the up-down direction.

### REFERENCE TO RELATED APPLICATIONS

This application claims priorities from Japanese Patent Application No. 2024-032167 filed on Mar. 4, 2024 and Japanese Patent Application No. 2024-032169 filed on Mar. 4, 2024. The entire contents of the priority applications are incorporated herein by reference.

### BACKGROUND ART

A known ink-jet recording head includes two ink pools (common channels) disposed in an overlapping manner in the up-down direction, and a plurality of individual channels each including a nozzle and a pressure chamber communicating with the nozzle. In a certain known ink-jet recording head, the plurality of individual channels includes a plurality of first individual channels each communicating with an upper ink pool of the two ink pools and a plurality of second individual channels each communicating with a lower ink pool of the two ink pools, and these first individual channels and second individual channels are located in a partially overlapping manner in the up-down direction, and a plurality of nozzles are located at high density.

### SUMMARY

In the above-described ink-jet recording head, the plurality of ink pools are disposed in the overlapping manner in the up-down direction, and pressure chambers each of which is included in the plurality of second individual channels are located between the ink pools. This increases the height of the ink-jet recording head. In a case where the height of each of the ink pools is reduced in order to reduce the height of the ink-jet recording head, the volume of each of the ink pools is reduced, resulting in a shortage in the supply of ink from each of the ink pools to the respective individual channels.

In this regard, an object of the present disclosure is to provide a liquid ejecting head which contributes to preventing the head from becoming large-sized while locating nozzles at high density and maintaining the volume of the common channels.

A liquid ejecting head according to an aspect of the present disclosure includes a channel member having: a common channel extending in a first direction orthogonal to an up-down direction, and a plurality of individual channels each including a nozzle and a pressure chamber communicating with the nozzle, each of the plurality of individual channels communicating with the common channel. A plurality of individual channel rows each including the plurality of individual channels aligned in the first direction are disposed side by side in a second direction orthogonal to the up-down direction and the first direction. A first pressure chamber and a second pressure chamber overlap in the second direction, the first pressure chamber being included in a first individual channel row among the plurality of individual channel rows and the second pressure chamber being included in a second individual channel row adjacent to the first individual channel row among the plurality of individual channel rows. A first nozzle included in the first individual channel row and a second nozzle included in the second individual channel row are located on one side in the second direction with respect to the common channel. The first nozzle is located closer to the common channel than the second nozzle is in the second direction, and the first nozzle overlaps with the second pressure chamber in the up-down direction.

According to the liquid ejecting head of the present disclosure, the first nozzle overlaps with the second pressure chamber in the up-down direction, and thus a part of the communicating channel communicating with the first pressure chamber and the first nozzle included in the first individual channel row also overlaps with the second pressure chamber in the up-down direction. This contributes to locating the plurality of individual channels connected to the same common channel at high density. Therefore, the liquid ejecting head of the present disclosure is capable of contributing to preventing the channel member from becoming large-sized, while locating the plurality of nozzles at high density, maintaining length in the second direction (channel width) and height of the common channel, and securing the volume of the common channel.

### BRIEF DESCRIPTION OF DRAWINGS

FIG. 1 is a plan view of a printer including a head 1.

FIG. 2 is a block diagram depicting the electrical configuration of the printer.

FIG. 3 is a plan view of the head 1.

FIG. 4 is an enlarged view of an area IV depicted in FIG. 3 on the upper surface of a channel member.

FIG. 5 is a cross-sectional view of the head 1 along a V-V line in FIG. 4.

FIG. 6 is a cross-sectional view of the head 1 along a VI-VI line in FIG. 4.

FIG. 7 is a vertical cross-sectional view of the main components of another head 1.

FIG. 8A is a vertical cross-sectional view of the main components of yet another head 1, and FIG. 8B is a plan view of a horizontal part 317A2A depicted in FIG. 8A.

FIG. 9 is a plan view of a head 401.

FIG. 10 is an enlarged view of an area X depicted in FIG. 9 on the upper surface of a channel member.

FIG. 11A is a cross-sectional view of the head 401 along a XIA-XIA line in FIG. 10, and FIG. 11B is a cross-sectional view of the head 401 along a XIB-XIB line in FIG. 10.

FIG. 12A is a cross-sectional view of the head 401 along a XIIA-XIIA line in FIG. 10, and FIG. 12B is a cross-sectional view of the head 401 along a XIIB-XIIB line in FIG. 10.

FIG. 13 is an enlarged view depicting the first to fourth individual channels, and two common channels depicted in FIG. 10.

FIG. 14A is a view depicting a state in which first to fourth nozzles are located in a case where the head 401 is inclined by a predetermined angle θ with respect to a first direction in a plane orthogonal to the up-down direction, and FIG. 14B is a view depicting a state in which the first to fourth nozzles are located in a case where another head is inclined by the predetermined angle θ with respect to the first direction in the plane orthogonal to the up-down direction.

### DESCRIPTION

### First Embodiment

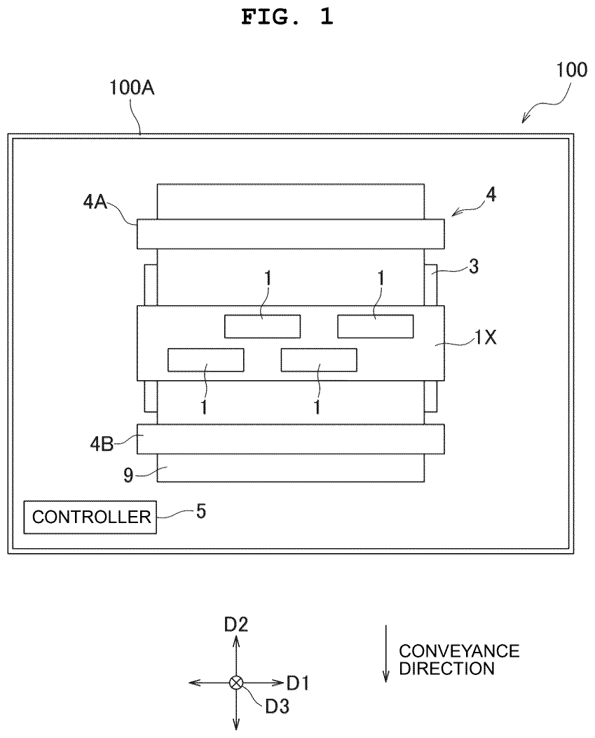

First, the overall configuration of a printer 100 including a head 1 according to a first embodiment of the present disclosure will be described, with reference to FIG. 1. Note that in the following description, a first direction D1 and a second direction D2 are horizontal directions and are orthogonal to an up-down direction D3. The up-down direction D3 in the present embodiment is along the vertical direction, but the up-down direction D3 may be an up-down direction crossing the vertical direction and the horizontal direction. The first direction D1 is orthogonal to the second direction D2.

### Overall Configuration of Printer

The printer 100 includes a casing 100A, a head unit 1X, a platen 3, a conveyor 4, and a controller 5. The head unit 1X, the platen 3, the conveyor 4, and the controller 5 are disposed inside the casing 100A. The printer 100 further includes a button (not depicted in the drawings) disposed in the outer surface of the casing 100A.

The length of the head unit 1X in the first direction D1 is longer than the length of the head unit 1X in a conveyance direction along the second direction D2. The first direction D1 is a direction along the width of a sheet 9. The head unit 1X is fixed to the casing 100A. The type of the head unit 1X is a line system.

The head unit 1X includes four heads 1. The four heads 1 are disposed in a staggered manner in the first direction D1. The length in the first direction D1 of each of the four heads 1 is longer than the length in the second direction D2 of each of the four heads 1.

The platen 3 is a plate along the plane orthogonal to the up-down direction D3, and is disposed below the head unit 1X. The sheet 9 is supported on the upper surface of the platen 3.

The conveyor 4 has two roller pairs A4 and 4B disposed, with the platen 3 interposed therebetween in the second direction D2. In a case where a conveying motor 4C is driven by control of the controller 5, the two roller pairs A4 and 4B rotate while holding the sheet 9, and the sheet 9 is conveyed in the conveyance direction along the second direction D2.

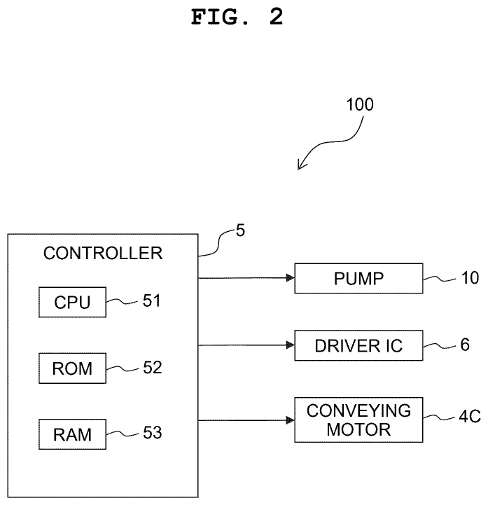

As depicted in FIG. 2, the controller 5 includes a CPU 51, a ROM 52, and a RAM 53. The CPU 51 executes various kinds of control in accordance with a program and data stored in the ROM 52 and/or the RAM 53, based on data input from an external apparatus or the above-described button. The external apparatus is, for example, a personal computer (PC).

The ROM 52 stores the program and data to be used in a case where the CPU 51 performs the various kinds of control. The RAM 53 temporarily stores data to be used in a case where the CPU 51 executes the program.

### Head 1

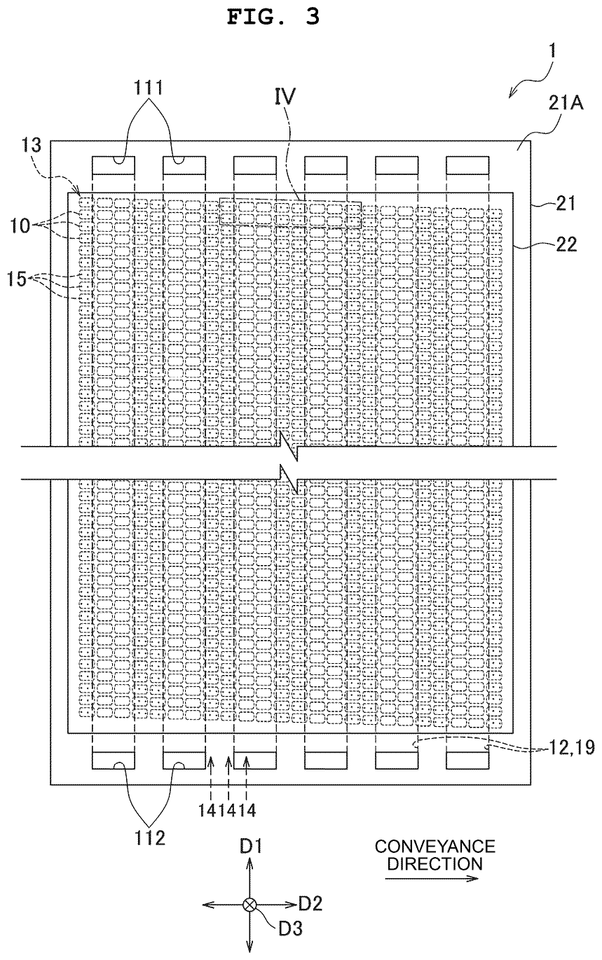

As depicted in FIG. 3, each of the four heads 1 has a channel member 21 and an actuator member 22. Both the channel member 21 and the actuator member 22 have a rectangular shape in which the length thereof in the first direction D1 is longer than the length thereof in the second direction D2 in the plane orthogonal to the up-down direction D3.

As depicted in FIG. 3, six supply ports 111 and six return ports 112 are open in an upper surface (surface) 21A of the channel member 21. The six supply ports 111 are located at one end in the first direction D1 of the channel member 21. The six return ports 112 are located at the other end in the first direction D1 of the channel member 21. Each of the six supply ports 111 and the six return ports 112 is connected to an ink tank via a tube. The channel member 21 has six common channels 12, a plurality of individual channels 13, and six damper chambers 19.

The six common channels 12 are disposed side by side in the second direction D2 and each extend in the first direction D1. Each of the six supply ports 111 is connected to one end in the first direction D1 of one of the six common channels 12. Each of the six return ports 112 is connected to the other end in the first direction D1 of one of the six common channels 12. Each of the six common channels 12 communicates with the ink tank via a corresponding supply port 111 among the six supply ports 111 and a corresponding return port 112 among the six return ports 112, and communicates with the plurality of individual channels 13.

Each of the six damper chambers 19 is located below a corresponding common channel 12 among the six common channels 12. The six damper chambers 19 are also disposed side by side in the second direction D2 and extend in the first direction D1.

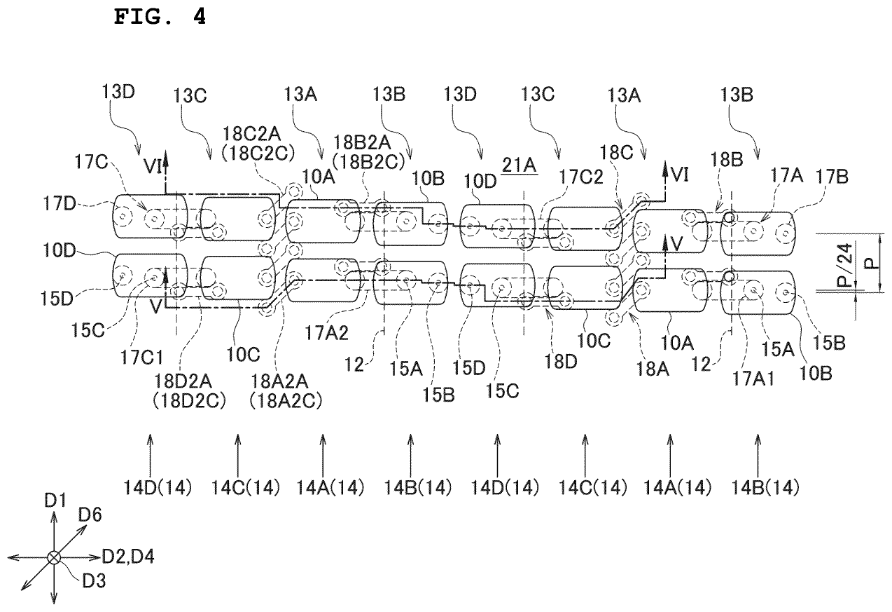

As depicted in FIGS. 4 to 6, each of the plurality of individual channels 13 includes one of a plurality of nozzles 15, one of a plurality of pressure chambers 16, one of a plurality of communicating channels 17, and one of a plurality of connecting channel 18. One end of the communicating channel 17 communicates with the nozzle 15, and the other end of the communicating channel 17 communicates with the pressure chamber 16. One end of the connecting channel 18 communicates with the common channel 12, and the other end of the connecting channel 18 communicates with the pressure chamber 16. The communicating channel 17 communicates with one end of the pressure chamber 16, and the connecting channel 18 communicates with the other end of the pressure chamber 16.

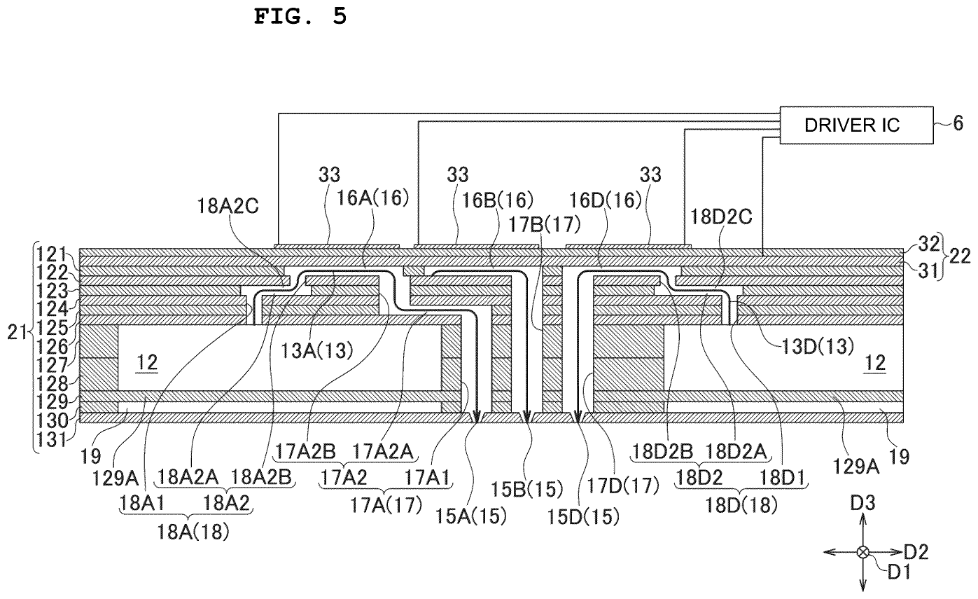

As depicted in FIG. 5, the channel member 21 includes eleven plates 121 to 131. Note that the channel member 21 may be constructed of eleven or more plates or ten or less plates. The plurality of pressure chambers 16 are formed in the plate 121 (the uppermost layer) among the eleven plates 121 to 131, and the plurality of nozzles 15 are formed in the plate 131 (the lowermost layer) among the eleven plates 121 to 131.

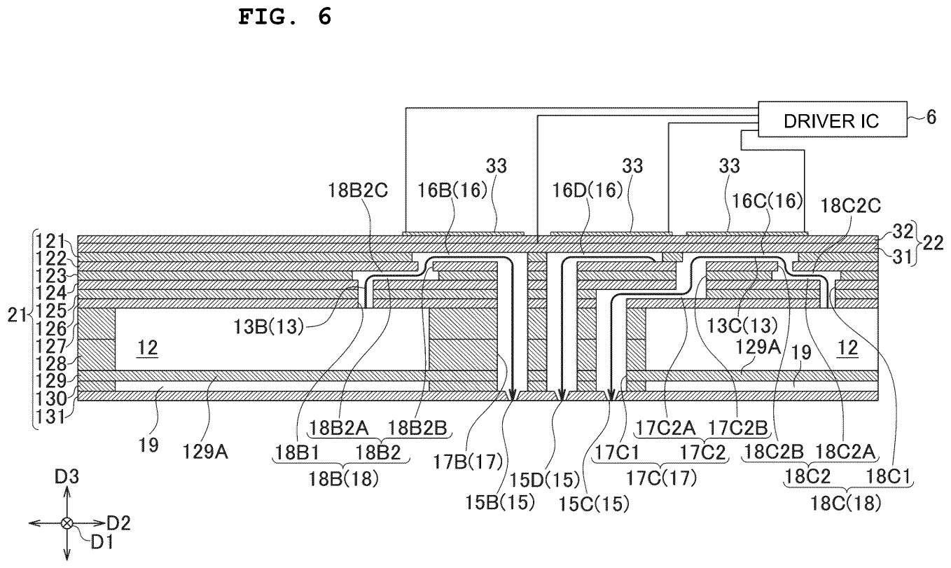

The plurality of pressure chambers 16 are open in the upper surface (upper surface 21A) of the plate 121, and the plurality of nozzles 15 are open in the lower surface of the plate 131. The opening of each of the nozzles 15 is circular, and the opening of each of the pressure chambers 16 is substantially rectangular which is elongated in the second direction D2. In other words, the length (width) in the first direction D1 of the pressure chamber 16 is shorter than a length in the second direction D2 of the pressure chamber 16. The nozzle 15 has a shape tapered downward, as depicted in FIGS. 5 and 6.

Each of the common channels 12 is constructed of two holes formed in the two plates 127, 128, respectively, and connected to each other. Each of the common channels 12 overlaps with all the pressure chambers 16 which communicate with each of the common channels 12 in the up-down direction D3.

Each of the six damper chambers 19 is constructed by closing a hole formed in a plate 130 with the two plates 129, 131. Parts, of the plate 129, each of which is sandwiched by one of the damper chambers 19 and one of the common channels 12 corresponding thereto, function as dampers 129A which absorb the change in pressure of the ink inside the respective common channels 12. In other words, even in a case where pressure generated in a certain pressure chamber 16 during ink ejection from a certain nozzle 15 corresponding to the certain pressure chamber 16 is propagated to the common channel 12, the damper 129A elastically deforms so as to attenuate the pressure, thereby preventing the phenomenon in which the pressure generated in the certain pressure chamber 16 is propagated to another pressure chamber 16 (so-called crosstalk).

As depicted in FIG. 3, the plurality of individual channels 13 are aligned in a first direction D1 so as to form 24 individual channel rows 14. These 24 individual channel rows 14 are disposed side by side in the second direction D2. Four rows of the 24 individual channel rows 14 correspond to one of the six common channels 12. For example, as depicted in FIGS. 4 to 6, four first individual channel row 14 which are a first individual channel row 14A to a fourth individual channel row 14D include first individual channels 13A, second individual channels 13B, third individual channels 13C and fourth individual channels 13D, respectively. The first individual channels 13A to the fourth individual channels 13D communicate with the same common channel 12 among the six common channels 12. Therefore, it can be considered that four rows of the 24 individual channel rows 14 correspond to one of the six common channels 12.

As depicted in FIG. 4, among the first individual channel rows 14A to the fourth individual channel rows 14D corresponding to each of the six common channels 12, each of first nozzles 15A included in the first individual channel row 14A and each of second nozzles 15B included in the second individual channel row 14B are located on one side in the second direction D2 (the right side in FIG. 4) with respect to a corresponding common channel 12 among the six common channels 12. Among the first individual channel rows 14A to fourth individual channel rows 14D corresponding to each of the six common channels 12, each of third nozzles 15C included in the third individual channel row 14C and each of fourth nozzles 15D included in the fourth individual channel row 14D are located on the other side in the second direction D2 (the left side in FIG. 4) with respect to a corresponding common channel 12 among the six common channels 12.

The first individual channel 13A included in the first individual channel row 14A and the third individual channel 13C included in the third individual channel row 14C have the same channel structure including the channel shape and size. More specifically, the first individual channel 13A and the third individual channel 13C are located point-symmetrically with respect to a middle point of a line segment connecting the first nozzle 15A and the third nozzle 15C in the plane orthogonal to the up-down direction D3.

The second individual channel 13B included in the second individual channel row 14B and the fourth individual channel 13D included in the fourth individual channel row 14D also have the same channel structure including the channel shape and size. More specifically, the second individual channel 13B and the fourth individual channel 13D are located point-symmetrically with respect to a middle point of a line segment connecting the second nozzle 15B and the fourth nozzle 15D in the plane orthogonal to the up-down direction D3.

The detailed configuration of each of the first individual channel 13A and the second individual channel 13B will be described below.

As depicted in FIG. 5, each of the first individual channels 13A includes a first nozzle 15A, a first pressure chamber 16A, a communicating channel 17A, and a connecting channel 18A. As depicted in FIG. 4, the first pressure chamber 16A overlaps, in the second direction D2, with a second pressure chamber 16B included in a second individual channel 13B adjacent to the first individual channel 13A. The connecting channel 18A corresponds to a “first connecting channel” of the present disclosure.

The communicating channel 17A has a first up-down channel 17A1 and a first communicating channel 17A2. The first up-down channel 17A1 extends upward from the first nozzle 15A along the up-down direction D3. As depicted in FIG. 4, the first up-down channel 17A1 overlaps with the second pressure chamber 16B included in the second individual channel 13B in the up-down direction D3. Further, the first up-down channel 17A1 is constructed of five holes formed, respectively, in the five plates 126 to 130 which are connected to one another, and has a diameter greater than the diameter of the first nozzle 15A.

Furthermore, the first nozzle 15A also overlaps with the second pressure chamber 16B in the up-down direction D3. In the second direction D2, the first nozzle 15A is located closer to the corresponding common channel 12 than the second nozzle 15B included in the second individual channel 13B is.

The first communicating channel 17A2 has a horizontal part 17A2A connected to the upper end of the first up-down channel 17A1 and a vertical part 17A2B connected to the first pressure chamber 16A. The horizontal part 17A2A is a hole formed in the plate 125, and extends from the upper end of the first up-down channel 17A1 in a fourth direction D4 parallel to the second direction D2. As depicted in FIG. 4, the horizontal part 17A2A in the present embodiment has the length in the first direction D1 which is approximately the same as the length in the first direction D1 of the first up-down channel 17A1. The horizontal part 17A2A corresponds to a “first extending part” of the present disclosure.

As depicted in FIG. 5, the vertical part 17A2B is constructed of three holes formed, respectively, in the three plates 122 to 124 and connected to one another. The vertical part 17A2B extends upward toward the first pressure chamber 16A from an end, of the horizontal part 17A2A, which is close to the first pressure chamber 16A. In this manner, the first communicating channel 17A2 is constructed of the four holes formed, respectively, in the four plates 122 to 125 and connected to one another.

As depicted in FIG. 5, the connecting channel 18A has a first part 18A1 and a second part 18A2. The first part 18A1 is constructed of three holes formed, respectively, in the three plates 124 to 126 and connected to one another, and is connected to the upper end of the common channel 12.

The second part 18A2 has a horizontal part 18A2A connected to the upper end of the first part 18A1 and a vertical part 18A2B connected to the first pressure chamber 16A. The horizontal part 18A2A is a hole formed in the plate 123, and extends from the upper end of the first part 18A1 toward the first pressure chamber 16A along a sixth direction D6 (see FIG. 4) which crosses the first direction D1 and the second direction D2 and is orthogonal to the up-down direction D3. Further, as depicted in FIG. 4, the horizontal part 18A2A has a throttle part 18A2C which throttles a flow amount of the liquid. The throttle part 18A2C is formed in a central part in the sixth direction D6 of the horizontal part 18A2A, and has a channel width (length in the direction orthogonal to the sixth direction D6) smaller than a channel width of the first part 18A1. In the present embodiment, although both ends in the sixth direction D6 of the horizontal part 18A2A have a channel width greater than the channel width of the throttle part 18A2C, the horizontal part 18A2A may have a channel width which is constant over the entirety of the length of the horizontal part 18A2A. The horizontal part 18A2A corresponds to a “third extending part” of the present disclosure.

As depicted in FIG. 5, the vertical part 18A2B is a hole formed in the plate 122, and extends upward toward the first pressure chamber 16A, from an end, of the horizontal part 18A2A, which is close to the first pressure chamber 16A. In this manner, the second part 18A2 is constructed of the two holes formed, respectively, in the two plates 122, 123 and connected to each other.

As depicted in FIG. 6, the second individual channel 13B includes a second nozzle 15B, a second pressure chamber 16B, a communicating channel 17B, and a connecting channel 18B. The communicating channel 17B corresponds to a “second up-down channel” of the present disclosure, and the connecting channel 18B corresponds to a “second connecting channel” of the present disclosure.

The communicating channel 17B extends upward along the up-down direction D3 from the second nozzle 15B. The communicating channel 17B is constructed of nine holes formed, respectively, in the nine plates 122 to 130 and connected to one another, and has a diameter greater than the diameter of the second nozzle 15B.

The channel shape and size of the communicating channel 17B are adjusted so that the channel resistance and inertance of the communicating channel 17B are the same as the channel resistance and inertance of the communicating channel 17A. The inertance of a channel is expressed as ρL/S [kg/m⁴], in a case where S [m²] is the cross-sectional area of the channel, L [m] is the length of the channel, and ρ [kg/m³] is the density of the ink inside the channel.

As depicted in FIG. 6, the connecting channel 18B has a first part 18B1 and a second part 18B2. The first part 18B1 is constructed of three holes formed, respectively, in the three plates 124 to 126 and connected to one another, and is connected to the upper end of the common channel 12. A connecting position at which the connecting channel 18B is connected to the common channel 12 is separated, in the second direction D2, from a connecting position at which the connecting channel 18A is connected to the common channel 12.

The second part 18B2 has a horizontal part 18B2A connected to the upper end of the first part 18B1 and a vertical part 18B2B connected to the second pressure chamber 16B. The horizontal part 18B2A is a hole formed in the plate 123, and extends from the upper end of the first part 18B1 toward the second pressure chamber 16B along a fifth direction D5 parallel to the second direction D2, as depicted in FIG. 4. Further, as depicted in FIG. 4, the horizontal part 18B2A has a throttle part 18B2C which throttles the flow amount of the liquid. The horizontal part 18B2A corresponds to a “second extending part” of the present disclosure.

The horizontal part 18B2A of the connecting channel 18B is located at a different height from the horizontal part 17A2A of the first communicating channel 17A2. With this, the horizontal part 17A2A and the horizontal part 18B2A can be disposed so as to overlap in the up-down direction D3, without interfering with each other, as depicted in FIG. 4. This eliminates the need to greatly separate the first individual channel 13A and the second individual channel 13B in the horizontal direction, allowing the first individual channels 13A and the second individual channels 13B to be disposed at high density. Owing to this configuration, the size of the channel member 21 is less likely to be great in the direction orthogonal to the up-down direction D3.

As depicted in FIG. 6, the vertical part 18B2B is a hole formed in the plate 122, and extends upward toward the second pressure chamber 16B from an end, of the horizontal part 18B2A, which is close to the second pressure chamber 16B. In this manner, the second part 18B2 is constructed of the two holes formed, respectively, in the two plates 122, 123 and connected to each other.

In the present embodiment, although the connecting channel 18A and the connecting channel 18B have the different connecting positions and inclinations with respect to pressure chambers 16, with which the connecting channel 18A and the connecting channel 18B communicate, respectively, in the plane orthogonal to the up-down direction D3, the connecting channel 18A and the connecting channel 18B have the same channel length and the same channel width. In other words, the connecting channel 18A and the connecting channel 18B have the same channel shape and size.

The first pressure chamber 16A and the connecting channel 18A included in the first individual channel 13A and the second pressure chamber 16B and the connecting channel 18B included in the second individual channel 13B have the same channel shape and size, and also have the same channel resistance and the same inertance. Further, the communicating channel 17A included in the first individual channel 13A and the communicating channel 17B included in the second individual channel 13B have the different channel shapes and sizes but have the same channel resistance and inertance. Accordingly, the first individual channel 13A and the second individual channel 13B have the same channel resistance and inertance.

The configuration of the third individual channel 13C and the configuration of the fourth individual channel 13D are similar, respectively, to the configuration of the first individual channel 13A and the configuration of the second individual channel 13B as described above, and thus the third individual channel 13C and the fourth individual channel 13D will not be described in detail. As depicted in FIG. 6, the third individual channel 13C includes a third nozzle 15C, a third pressure chamber 16C, a communicating channel 17C, a third up-down channel 17C1, a third communicating channel 17C2, a horizontal part 17C2A, a vertical part 17C2B, a connecting channel 18C, a first part 18C1, a second part 18C2, a horizontal part 18C2A, a vertical part 18C2B, and a throttle part 18C2C. The connecting channel 18C corresponds to a “third connecting channel” of the present disclosure.

As depicted in FIG. 5, the fourth individual channel 13D includes a fourth nozzle 15D, a fourth pressure chamber 16D, a communicating channel 17D, a connecting channel 18D, a first part 18D1, a second part 18D2, a horizontal part 18D2A, a vertical part 18D2B, and a throttle part 18D2C.

As depicted in FIG. 4, the third pressure chamber 16C overlaps with the fourth pressure chamber 16D in the second direction D2. More specifically, the first pressure chamber 16A to the fourth pressure chamber 16D included, respectively, in the first individual channel 13A to the fourth individual channel 13D overlap with one another in the second direction D2. Further, the third nozzle 15C also overlaps with the fourth pressure chamber 16D in the up-down direction D3. In the second direction D2, the third nozzle 15C is located closer to the corresponding common channel 12 than the fourth nozzle 15D is. The connecting channel 18A corresponds to the “first connecting channel” of the present disclosure.

As depicted in FIG. 4, the horizontal part 18C2A of the connecting channel 18C extends in the sixth direction D6 and is located side by side, in the first direction D1, with the horizontal part 18A2A included in the connecting channel 18A. This allows the first individual channel 13A and the third individual channel 13C to be located close to each other in the second direction D2. The horizontal part 18C2A corresponds to a “fourth horizontal part” of the present disclosure.

In each of the individual channel rows 14, as depicted in FIG. 4, the plurality of nozzles 15 are aligned in the first direction D1 at a predetermined pitch P. Two nozzles 15 included, respectively, in two individual channels 13 adjacent to each other in the second direction D2 are located apart in the first direction D1 by a distance corresponding to 1/24 of the pitch P. With this, in a case where the recording resolution at the pitch P is 100 dpi, recording resolution of 2400 dpi is realized by all the nozzles 15.

The ink in the ink tank is supplied to each of the six common channels 12 via one of the six supply ports 111 corresponding thereto by driving a pump 10 depicted in FIG. 2 under the control of the controller 5, and then the ink is distributed from the six common channels 12 to the plurality of individual channels 13.

In each of the plurality of individual channels 13, the volume of the pressure chamber 16 is reduced by driving an actuator part 35 which will be described later, and pressure is applied to the ink in the pressure chamber 16, thereby causing the ink to pass through the communicating channel 17 and to be ejected as an ink droplet from the nozzle 15.

The ink supplied from each of the six supply ports 111 moves in one of the six common channels 12 corresponding thereto from the one end to the other end in the first direction D1, and reaches one of the six return ports 112 corresponding thereto. The ink which reaches each of the six return ports 112 is returned to the ink tank via the tube.

As depicted in FIGS. 3, 5, and 6, the actuator member 22 is fixed to the upper surface 21A of the channel member 21. The actuator member 22 includes a vibration plate 31 made of metal, a piezoelectric layer 32, and a plurality of individual electrodes 33.

Parts, of the actuator member 22, each of which overlaps with one of the plurality of pressure chambers 16 corresponding thereto in the up-down direction D3 function as actuator parts 35. Each of the actuator parts 35 is independently deformable in accordance with the potential applied to one of the plurality of individual electrodes 33 corresponding thereto.

Each of the actuator parts 35 is a thin-film piezoelectric element. The thin-film piezoelectric element is a so-called micro electro mechanical system (MEMS). The actuator parts 35 are formed by sequentially depositing a thin film which becomes the piezoelectric layer 32 and a thin film which becomes the plurality of individual electrodes 33, on the upper surface of the vibration plate 31.

The vibration plate 31 is disposed on the upper surface 21A of the channel member 21 so as to cover the plurality of pressure chambers 16. The piezoelectric layer 32 is disposed on the upper surface of the vibration plate 31. Each of the plurality of individual electrodes 33 is disposed on the upper surface of the piezoelectric layer 32 so as to overlap with one of the pressure chambers 16 corresponding thereto in an up-down direction D3.

The vibration plate 31 and the plurality of individual electrodes 33 are electrically connected to a driver IC 6 (FIG. 2). The driver IC 6 maintains the potential of the vibration plate 31 at the ground potential, whereas the driver IC 6 changes the potential of each of the plurality of individual electrodes 33. The vibration plate 31 functions as a common electrode which is common to the plurality of actuator parts 35.

The driver IC 6 generates a drive pulse signal based on a control signal from the controller 5, and supplies the drive pulse signal to each of the plurality of individual electrodes 33. The drive pulse signal changes the potential of each of the plurality of individual electrodes 33 between a predetermined driving potential and the ground potential. In this manner, the actuator part 35 is driven, and the pressure is applied to the ink in the pressure chamber 16, causing an ink droplet to pass through the communicating channel 17 and to be ejected from the nozzle 15.

As described above, according to the head 401 of the present embodiment, owing to the first nozzle 15A overlapping with the second pressure chamber 16B in the up-down direction D3, a part of the communicating channel 17A, which communicates with the first pressure chamber 16A and the first nozzle 15A included in the first individual channel row 14A also overlaps with the second pressure chamber 16B in the up-down direction D3, and the individual channels 13A, 13B connected to the same common channel 12 can be located at high density. In other words, even in a case where the common channels are not located to overlap each other vertically, the individual channels 13A, 13B can be located at high density while maintaining the length in the second direction D2 (channel width) of the common channel 12. Therefore, the channel member 12 can be prevented from becoming large-sized while locating the plurality of nozzles 15 at high density, maintaining the length in the second direction D2 and height of each of the common channels 12, and securing the volume of each of the common channels 12.

The head 1 includes the actuator member 22 having the plurality of actuator parts 35 each corresponding to one of the plurality of pressure chambers 16. In this case, the head 1 is less susceptible to the influence of non-uniformity during the manufacture of the actuator member 22 itself than in a case where the head 1 includes a plurality of actuator members each of which has an actuator part 35 corresponding to one of the pressure chambers 16. Therefore, in the head 1 of the present embodiment, the ink ejection characteristic is less likely to vary among the plurality of nozzles 15.

The first individual channel 13A and the second individual channel 13B have the same channel resistance. As a result, the channel resistances of the first individual channel 13A to the fourth individual channel 13D are also the same. Owing to this, the ink flows easily from each of the common channels 12 to any one of the plurality of individual channels 13. Therefore, even in a case where the same pressure is applied to the ink in the plurality of pressure chambers 16, the ink ejection characteristic is less likely to vary among the plurality of nozzles 15.

The first individual channel 13A and the second individual channel 13B have the same inertance. Owing to this, the first individual channel 13A to the fourth individual channel 13D also have the same inertance. This reduces non-uniformity in the acoustic length (AL) which is a round-trip propagation time of a pressure wave in each of the plurality of individual channels 13. As a result, the ink ejection characteristic is less likely to vary among the plurality of nozzles 15.

Further, the connecting channels 18A and 18B have the same channel length and the same channel width. Owing to this, the first individual channel 13A and the second individual channel 13B are more likely to have the same channel resistance or the same inertance.

Furthermore, the first individual channel 13A and the third individual channel 13C, which communicate with the same common channel 12, have the same channel configuration, and the second individual channel 13B and the fourth individual channel 13D, which communicate with the same common channel 12, have the same channel configuration. Owing to this, the ink ejection characteristic is less likely to vary among the plurality of nozzles 15, in a similar manner as described above.

The first communicating channel 17A2 included in the first individual channel 13A has the horizontal part 17A2A extending in the fourth direction D4. Owing to this, even in a case where the first up-down channel 17A1 is shorter than the communicating channel 17B, the adjustment so as to make the channel resistance and/or inertance of the first individual channel 13A and the second individual channel 13B the same can be easily performed by the horizontal part, of the first communicating channel 17A2A, which extends in the fourth direction D4.

The connecting position at which the connecting channel 18B connects to the common channel 12 is separated, in the second direction D2, from the connecting position at which the connecting channel 18A connects to the common channel 12. In a presumed case where these two connecting positions are not separated in the second direction D2 but are located side by side in the first direction D1, the ink at the same position in the common channel 12 flows to the individual channel 13 in the second direction D2. Due to this, ink each at positions separated from the connecting position with respect to the common channel 12 in the second direction D2 stagnates without flowing to the individual channel 13. However, in the present embodiment, since these two connecting positions are separated in the second direction D2, the ink flows from at least two positions in the second direction D2 of the common channel 12 to the individual channel 13. Therefore, the stagnation of the ink is less likely to occur in the common channel 12.

### Modifications

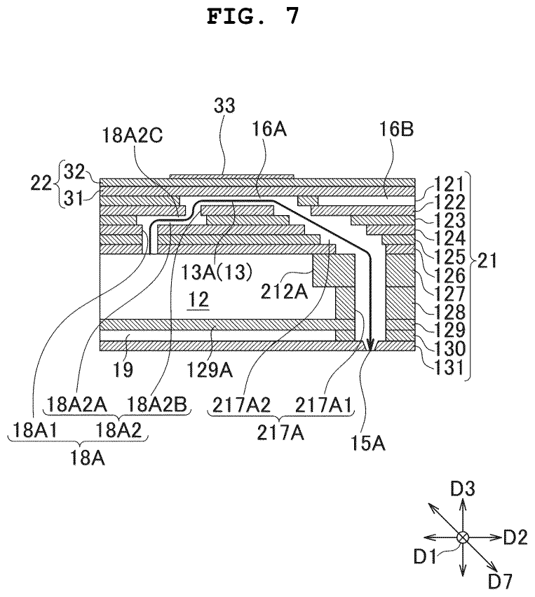

As a first modification, the first individual channel 13A may include a communicating channel 217A depicted in FIG. 7, instead of the above-described communicating channel 17A. The communicating channel 217A in the first modification has a first up-down channel 217A1 and a first communicating channel 217A2, as depicted in FIG. 7. The first up-down channel 217A1 extends upward from the first nozzle 15A along the up-down direction D3. The first up-down channel 217A1 overlaps with the second pressure chamber 16B included in the second individual channel 13B in the up-down direction D3. Further, the first up-down channel 217A1 is constructed of four holes formed, respectively, in the four plates 127 to 130 and connected to one another, and has a diameter greater than the diameter of the first nozzle 15A.

The first communicating channel 217A2 communicates with the first pressure chamber 16A and the first up-down channel 217A1. The first communicating channel 217A2 extends, without bending, at a location below the second pressure chamber 16B in a third direction D7 which crosses the second direction D2 and the up-down direction D3. The first communicating channel 217A2 overlaps, in the up-down direction D3, with a common channel 12 which is one of the six communication channels 12 and with which the first communicating channel 217A2 communicates. Moreover, the first communicating channel 217A2 is constructed of five holes formed, respectively, in the five plates 122 to 126 and connected to one another. More specifically, the first communicating channel 217A2 is constructed of the five holes formed, respectively, in the five plates 122 to 126 and connected to one another in a stepped manner.

With the first communicating channel 217A2 configured in such a manner, the channel resistance in the first communicating channel 217A2 becomes smaller than the channel resistance in a channel bent at, for example, 90 degrees between the first pressure chamber 16A and the first up-down channel 217A1. Owing to this, the ink can easily flow from the first pressure chamber 16A toward the first nozzle 15A.

Further, the channel shape and size of the communicating channel 217A are adjusted so that the communicating channel 217A has the channel resistance and inertance which are the same as the channel resistance and inertance of the above-described communicating channel 17A, thereby achieving the effect similar to the above-described effect.

Furthermore, the upper surface of the common channel 12 has a protruded part 212A which protrudes into the common channel 12 in an area overlapping with the first communicating channel 217A2. The protruded part 212A of the first modification is constructed of an upper side wall part, of the common channel 12, which is close to the first nozzle 15A. The upper side wall part is constructed of a hole which constructs a part, of the common channel 12, which is formed in the plate 127 and is formed to have a smaller hole diameter than a hole diameter of a hole constructing another part, of the common channel 12, which is formed in the plate 128. Since the common channel 12 has the protruded part 212A, the first communicating channel 217A2 and the common channel 12 are less likely to interfere with each other, even in a case where the first communicating channel 217A2 is formed in the channel member 21. Owing to this, the first communicating channel 217A2 which extends from the upper end of the first up-down channel 217A1 to the first pressure chamber 16A along the third direction D7 is easily formed in the channel member 21.

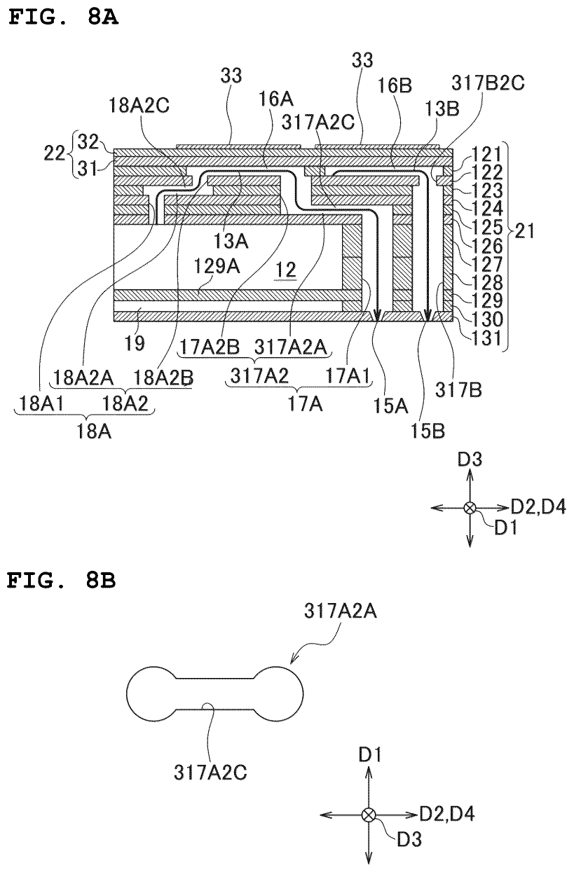

As a second modification, the first individual channel 13A may include a first communicating channel 317A2 having a horizontal part 317A2A depicted in FIG. 8, instead of the horizontal part 17A2A described above; and the second individual channel 13B may include a communicating channel 317B depicted in FIG. 8A, instead of the communicating channel 17B described above. The communicating channel 317B corresponds to the “second up-down channel” of the present disclosure.

The horizontal part 317A2A in the second modification is connected to the upper end of the first up-down channel 17A1 as depicted in FIG. 8A. The horizontal part 317A2A is a hole formed in the plate 125, and extends from the upper end of the first up-down channel 17A1 in a fourth direction D4 parallel to the second direction D2. Further, as depicted in FIG. 8B, the horizontal part 317A2A has a throttle part 317A2C which throttles the flow amount of the liquid. The throttle part 317A2C is formed in a central part in the fourth direction D4 of the horizontal part 317A2A, and the throttle part 317A2C has a channel width (length in the direction orthogonal to the fourth direction D4) which is smaller than the channel width of the first up-down channel 17A1. In the second modification, although both ends in the fourth direction D4 of the horizontal part 317A2A have a greater channel width than the channel width of the throttle part 317A2C, the horizontal part 317A2A may have a channel width which is constant over the entire length of the horizontal part 317A2A.

As depicted in FIG. 8A, the communicating channel 317B extends upward from the second nozzle 15B in the up-down direction D3. The communicating channel 317B is constructed of nine holes formed, respectively, in the nine plates 122 to 130 and connected to one another, and has a diameter greater than the diameter of the second nozzle 15B. The hole formed in the plate 122 has a hole diameter smaller than the diameter of each of the holes formed in the other plates 123 to 130. In other words, the communicating channel 317B also has a throttle part 317B2C in the upper part thereof which throttles the flow amount of the liquid. The channel width (hole diameter) of the throttle part 317B2C is smaller than the channel width of another part, of the communicating channel 317B, which is other than the upper part. The channel shape and size of the communicating channel 317B are adjusted so that the communicating channel 317B has the channel resistance and inertance which are same as the channel resistance and inertance of the communicating channel 17A including the horizontal part 317A2A. Owing to this, the effects similar to the effect described above can be obtained.

The first communicating channel 317A2 and the communicating channel 317B have the throttle part 317A2C and the throttle part 317B2C, respectively. Such a simple configuration is capable of reducing higher-order frequency component(s) in the individual channel 13 generated by the application of pressure to the ink in the pressure chamber 16 in a case where the ink is (to be) ejected from the nozzle 15. By reducing the higher-order frequency component(s), the pressure transmitted to the nozzle 15 is also stabilized, allowing a predetermined amount of ink to be ejected from the nozzle 15 in a stable manner.

### Second Embodiment

### Head 401

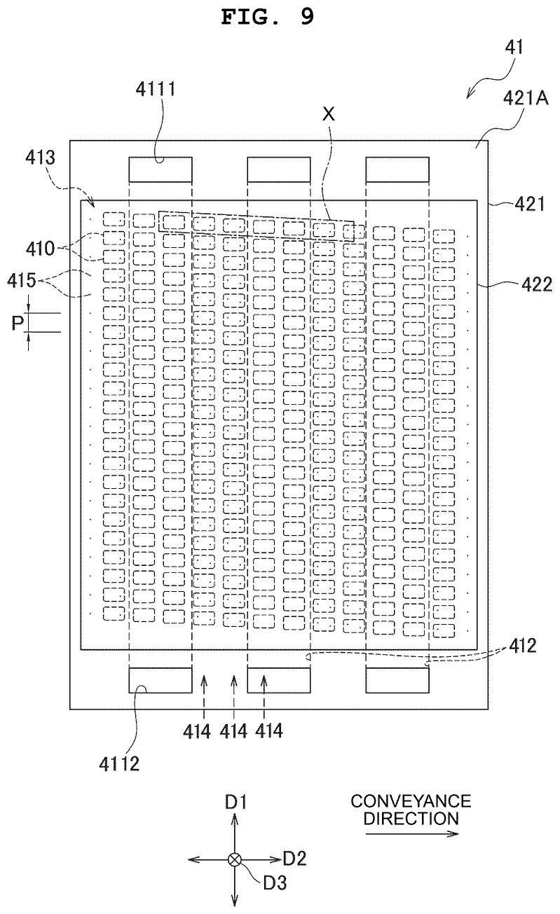

A head 401 according to a second embodiment of the present disclosure incudes a channel member 421 and an actuator member 422, as depicted in FIG. 9. Both the channel member 421 and the actuator member 422 have a rectangular shape in which the length thereof in the first direction D1 is longer than the length thereof in the second direction D2 in the plane orthogonal to the up-down direction D3.

As depicted in FIG. 9, three supply ports 4111 and three return ports 4112 are open in the upper surface (surface) 421A of the channel member 421. The three supply ports 4111 are located at one end in the first direction D1 of the channel member 421. The three return ports 4112 are located at the other end in the first direction D1 of the channel member 421. Each of the three supply ports 4111 and the three return ports 4112 is connected to an ink tank via a tube. The channel member 421 has three common channels 412, and a plurality of individual channels 413.

The three common channels 412 are disposed side by side in the second direction D2 and each extend in the first direction D1. Each of the three supply ports 4111 is connected to one end in the first direction D1 of one of the three common channels 412. Each of the three return ports 4112 is connected to the other end in the first direction D1 of one of the three common channels 412. Each of the three common channel 412 communicates with the ink tank via a corresponding supply port 4111 among the three supply ports 4111 and a corresponding return port 4112 among the three return ports 4112, and communicates with the plurality of individual channels 413.

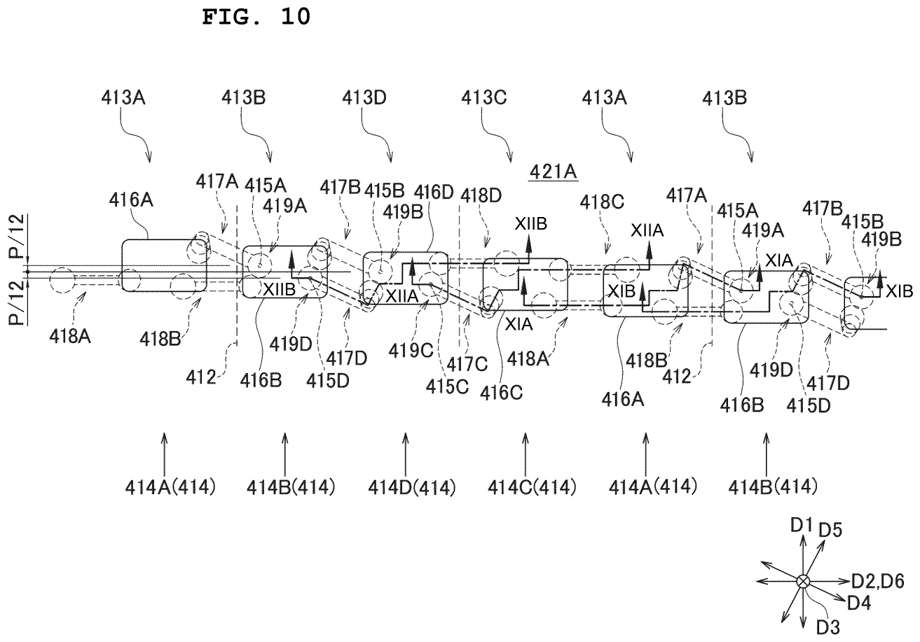

As depicted in FIGS. 10 to 12B, each of the plurality of individual channels 413 includes a nozzle 415, a pressure chamber 416, a communicating channel 417, a connecting channel 418, and an up-down channel 419. One end of the up-down channel 419 communicates with the nozzle 415, and the other end of the up-down channel 419 communicates with the communicating channel 417. One end of the communicating channel 417 communicates with the up-down channel 419, and the other end of the communicating channel 417 communicates with the pressure chamber 416. One end of the connecting channel 418 communicates with the common channel 412, and the other end of the connecting channel 418 communicates with the pressure chamber 416.

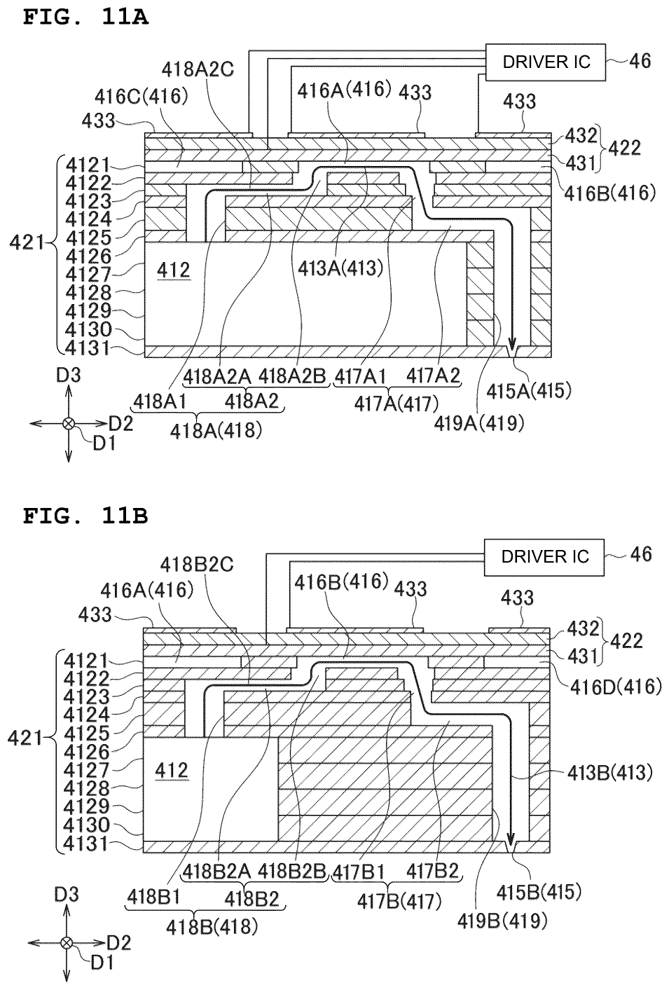

As depicted in FIGS. 11A and 11B, the channel member 421 includes eleven plates 4121 to 4131. Note that the channel member 421 may be constructed of eleven or more plates or ten or less plates. The pressure chamber 416 is formed as a plurality of pressure chambers 416 in the plate 4121 which is the uppermost layer among the eleven plates 4121 to 4131, and the nozzle 415 is formed as a plurality of nozzles 415 in the plate 4131 which is the lowermost layer among the eleven plates 4121 to 4131.

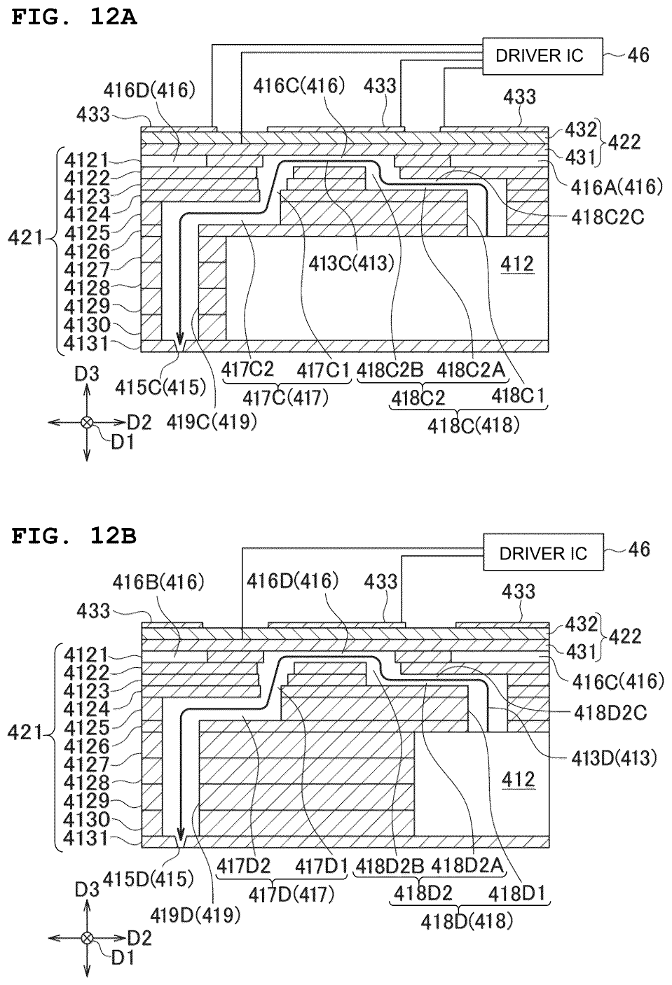

The plurality of pressure chambers 416 are open in the upper surface (upper surface 421A) of the plate 4121, and the plurality of nozzles 415 are open in the lower surface of the plate 4131. The opening of each of the nozzles 415 is circular, and the opening of each of the pressure chambers 416 is substantially rectangular which is elongated in the second direction D2. In other words, the length (width) in the first direction D1 of the pressure chamber 416 is shorter than the length in the second direction D2 of the pressure chamber 416. The nozzle 415 has a shape tapered downward, as depicted in FIGS. 11A and 11B and FIGS. 12A and 12B. Each of the three common channels 412 is constructed of four holes formed, respectively, in the four plates 4127 to 4130 and connected to one another.

As depicted in FIG. 9, the plurality of individual channels 413 are aligned in the first direction D1 and construct 12 individual channel rows 414. These 12 individual channel rows 414 are disposed side by side in the second direction D2. In each of the 12 individual channel rows 414, the plurality of nozzles 415 are aligned at a predetermined pitch P in the first direction D1. Further, all of the nozzles 415 are located at mutually different positions in the first direction D1. With this, in a case where the recording resolution at the pitch P is 100 dpi, a recording resolution of 1200 dpi is realized by all the nozzles 415.

Four rows of the 12 individual channel rows 414 correspond to one of the three common channels 412. For example, as depicted in FIGS. 10 to 12B, the four individual channels rows 414 which are a first individual channel row 414A to a fourth individual channel row 414D include first individual channels 413A, second individual channels 413B, third individual channels 413C and fourth individual channels 413D, respectively. The first individual channels 413A, the second individual channels 413B, the third individual channels 413C and the fourth individual channels 413D communicate with the same common channel 412 among the three common channels 412. Therefore, it can be considered that four rows of the 12 individual channel rows 414 correspond to one of the three common channels 412.

As depicted in FIG. 10, among the first individual channel rows 414A to the fourth individual channel rows 414D corresponding to each of the three common channels 412, each of first nozzles 415A included in the first individual channel row 414A and each of second nozzles 415B included in the second individual channel row 414B are located on one side in the second direction D2 (the right side in FIG. 10) with respect to a corresponding common channels 412 among the three common channels 412. Among the first individual channel rows 414A to fourth individual channel rows 414D corresponding to each of the three common channels 412, each of third nozzles 415C included in the third individual channel row 414C and each of fourth nozzles 415D included in the fourth individual channel row 414D are located on the other side in the second direction D2 (the left side in FIG. 10) with respect to the corresponding common channels 412 among the three common channels 412.

All the plurality of individual channels 413 in the second embodiment have the same channel structure including the channel shape and size. A first individual channel 413A and a second individual channel 413B which are adjacent in the second direction D2 are located to be separated from each other in the second direction D2 so that the first nozzle 415A overlaps with the second pressure chamber 416B in the up-down direction D3, and that the first nozzle 415A and the second nozzle 415B are separated from each other by a distance corresponding to 1/12 of the pitch P in the first direction D1, as depicted in FIG. 10. Similarly, a third individual channel 413C and a fourth individual channel 413D which are adjacent in the second direction D2 are located to be separated from each other in the second direction D2 so that the third nozzle 415C overlaps with the fourth pressure chamber 416D in the up-down direction D3, and that the third nozzle 415C and the fourth nozzle 415D are separated from each other by a distance corresponding to 1/12 of the pitch P in the first direction D1. Further, a second individual channel 413B and a fourth individual channel 413D which are adjacent in the second direction D2 are located so that the second nozzle 415B overlaps with the fourth pressure chamber 416D in the up-down direction D3 and that the fourth nozzle 415D overlaps with the second pressure chamber 416B in the up-down direction D3.

The first individual channel 413A and the third individual channel 413C are located point-symmetrically with respect to a middle point of a line segment connecting the first nozzle 415A and the third nozzle 415C in the plane orthogonal to the up-down direction D3. The second individual channel 413B and the fourth individual channel 413D are located point-symmetrically with respect to a middle point of a line segment connecting the second nozzle 415B and the fourth nozzle 415D in the plane orthogonal to the up-down direction D3.

The first individual channel 413A and the fourth individual channel 413D are also located point-symmetrically with respect to a middle point of a line segment connecting the first nozzle 415A and the fourth nozzle 415D in the plane orthogonal to the up-down direction D3. The second individual channel 413B and the third individual channel 413C are also located point-symmetrically with respect to a middle point of a line segment connecting the second nozzle 415B and the third nozzle 415C in the plane orthogonal to the up-down direction D3.

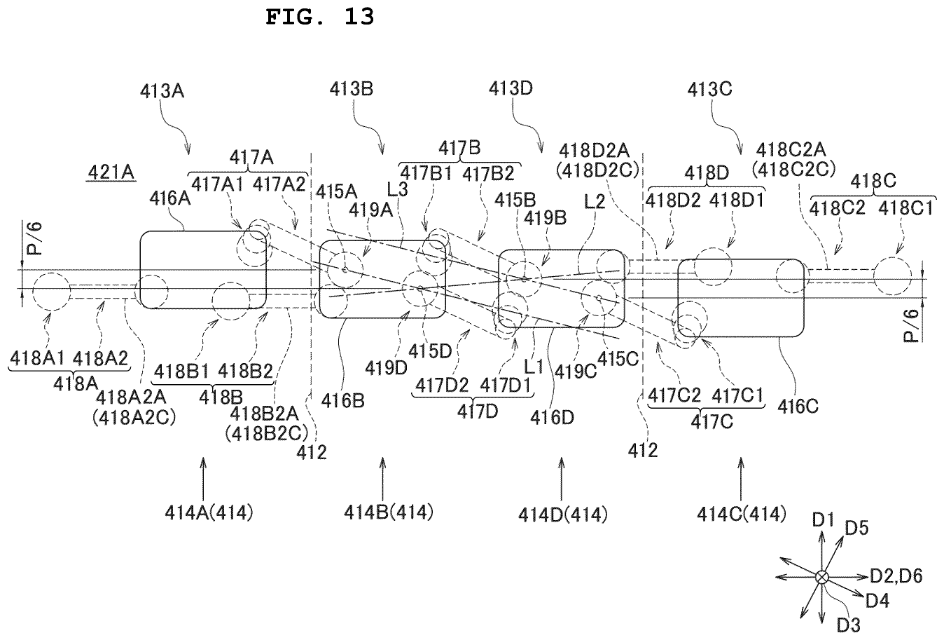

Further, the first nozzle 415A, the second nozzle 415B, the third nozzle 415C and the fourth nozzle 415D as the four nozzles 415 are located between two common channels 412 which are included in the three common channels 412 and which are adjacent in the second direction D2, as depicted in FIG. 13. The first nozzles 415A to the fourth nozzle 415D are located in the order of the first nozzle 415A, the fourth nozzle 415D, the second nozzle 415B, and the third nozzle 415C from the left in FIG. 13. The first nozzle 415A and the fourth nozzle 415D are separated by a distance corresponding to ⅙ of the pitch P in the first direction D1. The second nozzle 415B and the third nozzle 415C are also separated by the distance corresponding to ⅙ of the pitch P in the first direction D1. In other words, the first nozzles 415A to the fourth nozzle 415D are located in a staggered manner in the second direction D2.

In other words, among the first nozzles 415A to the fourth nozzle 415D, one nozzle 415 or two nozzles 415 are not located, in the plane orthogonal to the up-down direction D3, on a straight line passing through two nozzles 415 which are adjacent in the second direction D2 and which are other than the one nozzle 415 or the two nozzles 415. Namely, as depicted in FIG. 13, the second nozzle 415B and the third nozzle 415C are not located on a straight line L1 passing through the first nozzle 415A and the fourth nozzle 415D, the first nozzle 415A and the third nozzle 415C are not located on a straight line L2 passing through the fourth nozzle 415D and the second nozzle 415B, and the first nozzle 415A and the fourth nozzle 415D are not located on a straight line L3 passing through the second nozzle 415B and the third nozzle 415C.

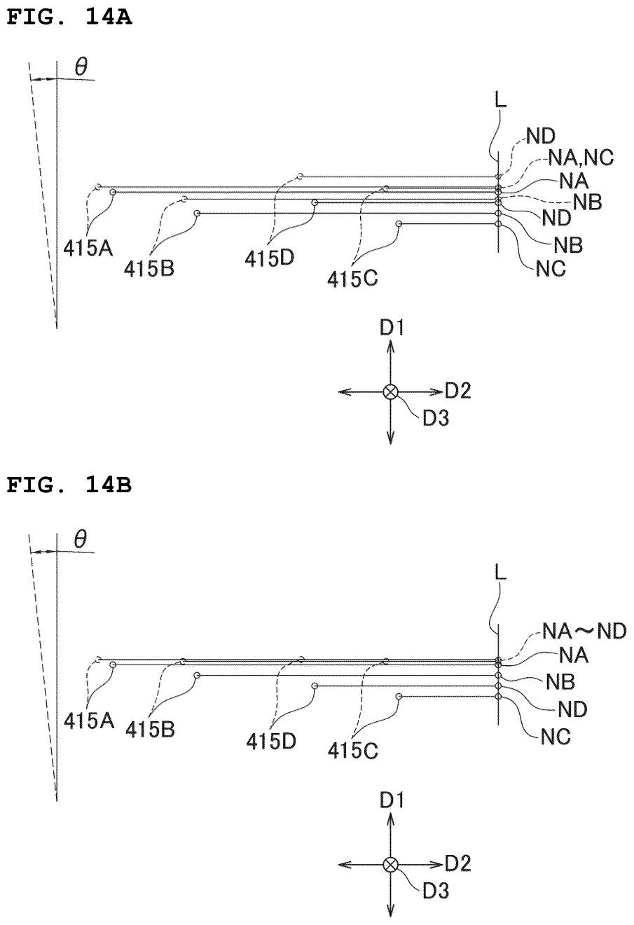

By locating the first nozzle 415A to the fourth nozzle 415D in this manner, projection points NA to ND (projection points indicated by hollow circles in FIG. 14A) which are projected, respectively, from the first nozzle 415A to the fourth nozzle 415D along the second direction D2 and onto a straight line L parallel to the first direction D1 are located at equal distances in the first direction D1, as depicted in FIG. 14A. In another head wherein the first nozzle 415A to the fourth nozzle 415D are located to be separated from one another at a distance corresponding to 1/12 of the pitch P to one side in the first direction DI (downward in FIG. 14B) further toward one side in the second direction D2 (rightward in FIG. 14B) as depicted in FIG. 14B, projection points NA to ND (projection points indicated by hollow circles in FIG. 14B) which are projected, respectively, from the first nozzle 415A to the fourth nozzle 415D along the second direction D2 and onto a straight line L in a manner similar to the manner in the above-described second embodiment are located at equal distances in the first direction D1.

However, in the manner in which the first nozzle 415A to the fourth nozzle 415D are located in the another head as depicted in FIG. 14B and in a case where the another head is disposed to be inclined at a predetermined angle θ 0 with respect to the first direction D1 in the plane orthogonal to the up-down direction D3, each of the first nozzle 415A to fourth nozzle 415D moves to a position thereof indicated by a broken line. In this case, projection points NA to ND which are projected, respectively, from the first nozzle 415A to the fourth nozzle 415D onto the straight line L along the second direction D2 are located to overlap and merge substantially in one location.

On the other hand, in the manner in which the first nozzle 415A to the fourth nozzle 415D are located in the present embodiment and in a case where the head 1 is located to be inclined in the same manner as described above regarding the another head, each of the first nozzle 415A to the fourth nozzle 415D moves to a position thereof indicated by a broken line depicted in FIG. 14A. In this case, although projection points NA and NC which correspond, respectively, to the two nozzles 415A and 415C among the projection points NA to ND which are projected, respectively, from the first nozzle 415A to the fourth nozzle 415D onto the straight line L along the second direction D2, are located to overlap and merge substantially in one location, projection points NB and ND which correspond, respectively, to the two nozzles 415B and 415D other than the nozzles 415A and 415C are located to be separated in the first direction D1. With this, since the first nozzle 415A to the fourth nozzle 415D are located in a staggered manner in the present embodiment as described above, even in a case where the channel member 421 is disposed to be inclined with respect to the first direction D1 in the plane orthogonal to the up-down direction D3, the resolution in the first direction D1 can be prevented from lowering.

The detailed configuration of the first individual channel 413A will be described below.

As depicted in FIG. 11A, each of the first individual channels 413A includes a first nozzle 415A, a first pressure chamber 416A, a communicating channel 417A, a connecting channel 418A, and an up-down channel 419A. As depicted in FIG. 10, the first pressure chamber 416A overlaps, in the second direction D2, with the second pressure chamber 416B included in the second individual channel 413B adjacent to the first individual channel 413A. The connecting channel 418A corresponds to the “first connecting channel” of the present disclosure.

As depicted in FIG. 11A, the up-down channel 419A extends upward from the first nozzle 415A along the up-down direction D3. As depicted in FIG. 10, the up-down channel 419A overlaps with the second pressure chamber 416B included in the second individual channel 413B in the up-down direction D3. Further, as depicted in FIG. 11A, the up-down channel 419A is constructed of five holes formed, respectively, in the five plates 4126 to 4130 which are connected to one another, and has a diameter greater than the diameter of the first nozzle 415A. In the second direction D2, the first nozzle 415A is located closer to the corresponding common channel 412 than the second nozzle 415B included in the second individual channel 413B is.

The communicating channel 417A includes a first part 417A1 having one end connected to the first pressure chamber 416A, and a second part 417A2 having one end connected to the other end of the first part 417A1 and the other end connected to the up-down channel 419A. The first part 417A1 is constructed of three holes formed, respectively, in the three plates 4122 to 4124 and connected to one another. The three holes constructing the first part 417A1 are formed so that the diameters thereof become smaller from the plate 4122 further toward the plate 4124. In other words, the cross-sectional area of the first part 417A1 becomes smaller in a stepped manner further downward from the first pressure chamber 416A. Further, as depicted in FIG. 11A and FIG. 13, the first part 417A1 extends further downward from the first pressure chamber 416A in a fifth direction D5 crossing the first direction D1 and the second direction D2.

As depicted in FIG. 11A and FIG. 13, the second part 417A2 is a hole formed in the plate 4125, and extends, in the plane orthogonal to the up-down direction D3, in a third direction D4 crossing the first direction D1, the second direction D2, and the fifth direction D5. That is, the communicating channel 417A has a bent shape in the plane orthogonal to the up-down direction D3, as depicted in FIG. 13. The second part 417A2 in the second embodiment has a length orthogonal to the third direction D4 which is smaller than the hole diameter of the up-down channel 419A. The second part 417A2 corresponds to the “first extending part” of the present disclosure.

As depicted in FIG. 11A, the connecting channel 418A has a first part 418A1 and a second part 418A2. The first part 418A1 is constructed of three holes formed, respectively, in the three plates 4124 to 4126 and connected to one another, and is connected to an upper end of the common channel 412.

The second part 418A2 has a horizontal part 418A2A connected to the upper end of the first part 418A1 and a vertical part 418A2B connected to the first pressure chamber 416A. The horizontal part 418A2A is a hole formed in the plate 4123, and extends from the upper end of the first part 418A1 toward the first pressure chamber 416A along a fourth direction D6 (see FIG. 13) which is parallel to the second direction D2. Further, as depicted in FIG. 13, the horizontal part 418A2A has a throttle part 418A2C which throttles a flow amount of the liquid. The throttle part 418A2C is formed in a central part in the fourth direction D6 of the horizontal part 418A2A, and has a channel width (length in the direction orthogonal to the fourth direction D6) smaller than a channel width of the first part 418A1. In the present embodiment, although both ends in the fourth direction D6 of the horizontal part 418A2A have a channel width greater than the channel width of the throttle part 418A2C, the horizontal part 418A2A may have a channel width which is constant over the entirety of the length of the horizontal part 418A2A. The horizontal part 418A2A corresponds to the “second extending part” of the present disclosure.

As depicted in FIG. 11A, the vertical part 418A2B is a hole formed in the plate 4122, and extends upward toward the first pressure chamber 416A, from an end, of the horizontal part 418A2A, which is close to the first pressure chamber 416A. In this manner, the second part 418A2 is constructed of the two holes formed, respectively, in the two plates 4122, 4123 and connected to each other.

The second individual channel 413B, the third individual channel 413C and the fourth individual channel 413D have a configuration similar to the configuration of the first individual channel 413A as described above, and thus the configuration of each of the second individual channel 413B, the third individual channel 413C and the fourth individual channel 413D will not be described in detail. As depicted in FIG. 11B, the second individual channel 413B includes a second nozzle 415B, a second pressure chamber 416B, a communicating channel 417B, a first part 417B1, a second part 417B2, a connecting channel 418B, a first part 418B1, a second part 418B2, a horizontal part 418B2A, a vertical part 418B2B, a throttle part 418B2C, and an up-down channel 419B. The connecting channel 418B corresponds to the “second connecting channel” of the present disclosure.

As depicted in FIG. 12A, the third individual channel 413C includes a third nozzle 415C, a third pressure chamber 416C, a communicating channel 417C, a first part 417C1, a second part 417C2, a connecting channel 418C, a first part 418C1, a second part 418C2, a horizontal part 418C2A, a vertical part 418C2B, a throttle part 418C2C, and an up-down channel 419C. As depicted in FIG. 12B, the fourth individual channel 413D includes a fourth nozzle 415D, a fourth pressure chamber 416D, a communicating channel 417D, a first part 417D1, a second part 417D2, a connecting channel 418D, a first part 418D1, a second part 418D2, a horizontal part 418D2A, a vertical part 418D2B, a throttle part 418D2C, and an up-down channel 419D.

As depicted in FIG. 13, the third pressure chamber 416C overlaps with the fourth pressure chamber 416D in the second direction D2. More specifically, the first pressure chamber 416A to the fourth pressure chamber 416D included, respectively, in the first individual channel 413A to the fourth individual channels 413D overlap with one another in the second direction D2. In the second direction D2, the third nozzle 415C is located closer to the corresponding common channel 412 than the fourth nozzle 415D is.

The second part 417B2 of the communicating channel 417B included in the second individual channel row 414B and the second part 417D2 of the communicating channel 417D included in the fourth individual channel row 414D overlap each other in the first direction D1 and are separated from each other in the first direction D1. Owing to this, the communicating channels 417B and 417D which are adjacent can be separated by a desired tolerance or more while locating the nozzles 415 at a high density. Accordingly, the communicating channels 417B and 417D can be prevented from communicating with each other due to an error during the manufacture of the channel member 421.

The ink in the ink tank is supplied to each of the three common channels 412 via one of the three supply ports 4111 corresponding thereto by driving the pump 10 depicted in FIG. 2 under the control of the controller 5, and then the ink is distributed from the three common channels 412 to the plurality of individual channels 413.

In each of the plurality of individual channels 413, the volume of the pressure chamber 416 is reduced by driving a actuator part 435 which will be described later, and pressure is applied to the ink in the pressure chamber 416, thereby causing the ink to pass through the communicating channel 417 and to be ejected as an ink droplet from the nozzle 415.

The ink supplied from each of the three supply ports 4111 moves in one of the three common channels 412 corresponding thereto from the one end to the other end in the first direction D1, and reaches one of the three return ports 4112 corresponding thereto. The ink which reaches each of the three return ports 4112 is returned to the ink tank via the tube.

As depicted in FIGS. 9, 11A, 11B, 12A and 12B, the actuator member 422 is fixed to the upper surface 421A of the channel member 421. The actuator member 422 includes a vibration plate 431 made of metal, a piezoelectric layer 432, and a plurality of individual electrodes 433.

Parts, of the actuator member 422, each of which overlaps with one of the plurality of pressure chambers 416 corresponding thereto in the up-down direction D3 function as actuator parts 435. Each of the actuator parts 435 is independently deformable in accordance with the potential applied to one of the plurality of individual electrodes 433 corresponding thereto.

Each of the actuator parts 435 is a thin-film piezoelectric element. The thin-film piezoelectric element is a so-called micro electro mechanical system (MEMS). The actuator parts 435 is formed by sequentially depositing a thin film which becomes the piezoelectric layer 432 and a thin film which becomes the plurality of individual electrodes 433, on the upper surface of the vibration plate 431.

The vibration plate 431 is disposed on the upper surface 421A of the channel member 421 so as to cover the plurality of pressure chambers 416. The piezoelectric layer 432 is disposed on the upper surface of the vibration plate 431. Each of the plurality of individual electrodes 433 is disposed on the upper surface of the piezoelectric layer 432 so as to overlap with each of the pressure chambers 416 corresponding thereto in an up-down direction D3.

The vibration plate 431 and the plurality of individual electrodes 433 are electrically connected to the driver IC 6. The driver IC 6 maintains the potential of the vibration plate 431 at the ground potential, whereas the driver IC 6 changes the potential of each of the plurality of individual electrodes 433. The vibration plate 431 functions as a common electrode which is common to the plurality of actuator parts 435.

The driver IC 6 generates a drive pulse signal based on a control signal from the controller 5, and supplies the drive pulse signal to each of the plurality of individual electrodes 433. The drive pulse signal changes the potential of each of the plurality of individual electrodes 433 between a predetermined driving potential and the ground potential. In this manner, the actuator part 435 is driven, and the pressure is applied to the ink in the pressure chamber 416, causing an ink droplet to pass through the communicating channel 417 and to be ejected from the nozzle 415.

As described above, according to the head 401 of the second embodiment, no individual channels 413 having different channel shapes are not included in the plurality of individual channels 413 connected to the same common channel 412. Therefore, even in a case where the plurality of nozzles 415 are located at high density, the liquid ejection characteristic is less likely to vary among the plurality of nozzles 415.

The first nozzle 415A overlaps with the second pressure chamber 416B in the up-down direction D3. Owing to this, the channel member 421 can be prevented from becoming large-sized in the second direction D2.

The third nozzle 415C overlaps with the fourth pressure chamber 416D in the up-down direction D3. Owing to this, the channel member 421 can be prevented from becoming large-sized in the second direction D2 while locating the plurality of nozzles 415 at high density.

The cross-sectional area of each of the first parts 417A1 to 417D1 of the communicating channel 417 becomes smaller in a stepped manner further downward from the pressure chamber 416. In such a presumed case where the upper end part of each of the first parts 417A1 to 417D1 is configured to have a smaller cross-sectional area than the cross-sectional area of the lower end part thereof, the pressure applied to the ink in the pressure chamber 416 is thereby rapidly attenuated and is less likely to be transmitted to the ink in the nozzle 415. In the present (or “second”?) embodiment, however, since the cross-sectional area of each of the first parts 417A1 to 417D1 becomes smaller in the stepped manner, the pressure applied to the ink in the pressure chamber 416 in a case where the ink is (to be) ejected from the nozzle 415 is easily transmitted to the ink in the nozzle 415. Owing to this, the ink can be easily ejected from the nozzle 415.

The second parts 417A2 to 417D2 of the communicating channel 417 and the horizontal parts 418A2A to 418D2A of the connecting channel 418 are located at mutually different heights. This prevents the second parts 417A2 to 417D2 and the horizontal parts 418A2A to 418D2A from interfering with one another in a case where the plurality of individual channels 413 are located adjacent to one another. Owing to this, the plurality of individual channels 413 can be located close to one another, thereby reducing the size of the channel member 413 in the direction orthogonal to the up-down direction D3.

The channel member 421 is constructed of the plurality of stacked plates 4121 to 4131. Owing to this, each of the pressure chambers 416, the nozzles 415, etc., in the plurality of individual channels 413 can be formed in the same plate.

The head 1 includes the actuator member 422 having the plurality of actuator parts 435 each corresponding to one of the plurality of pressure chambers 416. In this case, the head 401 is less susceptible to the influence of non-uniformity during the manufacture of the actuator member 422 itself than in a case where the head 401 includes a plurality of actuator members each of which has the actuator part 435 corresponding to one of the pressure chambers 416. Therefore, in the head 401 of the second embodiment, the ink ejection characteristic is less likely to vary among the plurality of nozzles 415.

All the plurality of nozzles 415 are located to be shifted from one another in the first direction D1, thereby improving the resolution in the first direction D1.

The connecting position at which the connecting channel 418B connects to the common channel 412 is separated, in the second direction D2, from the connecting position at which the connecting channel 418A connects to the common channel 412. In a presumed case where these two connecting positions are not separated in the second direction D2 but are located side by side in the first direction D1, the ink at the same position in the second direction D2 of the common channel 412 flows to the individual channel 413. Due to this, ink each at positions separated from the connecting position with respect to the common channel 412 in the second direction D2 stagnates without flowing to the individual channel 413. However, in the second embodiment, since these two connecting positions are separated in the second direction D2, the ink flows from at least two positions in the second direction D2 of the common channel 412 to the individual channel 413. Therefore, the stagnation of the ink is less likely to occur in the common channel 412.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

Although the present disclosure have been described above regarding the first and second embodiments and the modifications, the present disclosure is not limited to the above-described first and second embodiments and the modifications. Various changes can be made within the scope of the claims.

In the above-described first and second embodiments, the nozzles included, respectively, in the two individual channel rows 14, 412 corresponding to each of the common channels 12, 412 are located on each of the both sides in the second direction D2 with respect to the corresponding common channel 12, 412. However, the nozzles included, respectively, in the two individual channel rows may be located only on one side in the second direction D2 with respect to the corresponding common channel 12, 412.

Further, a plurality of actuator members each having the actuator part 35, 435 may be disposed on the upper surface 21A, 421A of the channel member 21, 421, instead of the actuator member 22, 422.

Furthermore, the first individual channel 13A and the second individual channel 13B may have mutually different channel resistances or inertances. Moreover, the first individual channel 13A and the third individual channel 13C may have mutually different channel structures, including the channel shape and size. Further, the second individual channel 13B and the fourth individual channel 13D may also have mutually different channel structures, including the channel shape and size.

The connecting channels 18A and 18B may have mutually different channel lengths and/or channel widths. Further, the connecting position at which the connecting channel 18A connects to the common channel 12 and the connecting position at which the connecting channel 8B connects to the common channel 12 may be located side by side in the first direction D1.

The horizontal part 18B2A of the connecting channel 18B and the horizontal part 17A2A of the first communicating channel 17A2 may be located at the same height. The horizontal part 18C2A of the connecting channel 18C and the horizontal part 18A2A of the connecting channel 18A do not have to be disposed side by side in the first direction D1.

In the above-described embodiments, although the electrodes constructing the actuator part 35 have a two-layered structure including the individual electrodes and the common electrode, the electrodes constructing the actuator part 35 may have a three-layered structure. For example, the three-layered structure means a configuration including a driving electrode to which a high potential and a low potential are selectively applied, a high potential electrode which is maintained at the high potential and a low potential electrode which is maintained at the low potential.

Further, the nozzle 415 included in one individual channel 413 does not have to overlap with the pressure chamber 416 included in another individual channel 413 in the up-down direction D3.

Furthermore, the second part 417B2 of the communicating channel 417B and the second part 417D2 of the communicating channel 417D do not have to overlap each other in the first direction D1. Moreover, the cross-sectional area of each of the first parts 417A1 to 417D1 of the communicating channel 417 may be the same or may increase in a stepped manner further downward from the pressure chamber 416.

The second parts 417A2 to 417D2 of the communicating channel 417 and the horizontal parts 418A2A to 418D2A of the connecting channel 418 may be located at the same height.

Among all the plurality of nozzles 415, nozzles 415 as a part of the plurality of nozzles 415 may be located at the same position in the first direction D1. As depicted in FIG. 14B, the first nozzle 415A to the fourth nozzle 415D may be located to be separated from one another at the distance corresponding to 1/12 of the pitch P to the one side in the first direction D1 (downward in FIG. 14B) further toward the one side in the second direction D2 (rightward in FIG. 14B).

In the second direction D2, the connection position at which the connecting channel 418B connects to the common channel 412 may be the same position as the connecting position at which the connecting channel 418A connects to the common channel 412.

The type of the liquid ejecting head is not limited to the line system, but may also be the serial system.

The object to which the liquid droplet is to be ejected is not limited to the sheet. For example, the object to which the liquid droplet is to be ejected may be cloth, a substrate, or plastic.

The liquid droplet ejected from the nozzle is not limited to the ink droplet. For example, the liquid droplet may be a droplet of a treatment liquid which agglutinates or precipitates a component in an ink.

The present disclosure is not limited to being applicable to printers, and is applicable also to facsimiles, copying machines, and multi-function peripherals. Further, the present disclosure is applicable also to a liquid droplet ejecting head for any usage other than the image recording. For example, the present disclosure is applicable to a liquid ejecting head which ejects a conductive liquid to a substrate so as to form a conductive pattern.

What is claimed is:

1. A liquid ejecting head comprising a channel member including:
a common channel extending in a first direction orthogonal to an up-down direction; and
a plurality of individual channels each including a nozzle and a pressure chamber communicating with the nozzle, each of the plurality of individual channels communicating with the common channel, wherein
a plurality of individual channel rows each including the plurality of individual channels aligned in the first direction are disposed side by side in a second direction orthogonal to the up-down direction and the first direction,
a first pressure chamber and a second pressure chamber overlap in the second direction, the first pressure chamber being included in a first individual channel row among the plurality of individual channel rows and the second pressure chamber being included in a second individual channel row adjacent to the first individual channel row among the plurality of individual channel rows,
a first nozzle included in the first individual channel row and a second nozzle included in the second individual channel row are located on one side in the second direction with respect to the common channel, and
the first nozzle is located closer to the common channel than the second nozzle is in the second direction, and the first nozzle overlaps with the second pressure chamber in the up-down direction.

2. The liquid ejecting head according to claim 1, wherein
a plurality of pressure chambers which includes the pressure chamber and each of which is included in one of the plurality of individual channels are open in a surface of the channel member, and
the liquid ejecting head further comprising an actuator member disposed in the surface and having a plurality of actuator parts each overlapping with one of the plurality of pressure chambers in the up-down direction.

3. The liquid ejecting head according to claim 1, wherein
a first individual channel included in the first individual channel row includes a first up-down channel extending from the first nozzle in the up-down direction, and a first communicating channel communicating with the first pressure chamber and the first up-down channel, and
the first communicating channel extends, without bending, at a location below the second pressure chamber in a third direction crossing the second direction and the up-down direction.

4. The liquid ejecting head according to claim 3, wherein
the first pressure chamber and the first communicating channel overlap with the common channel in the up-down direction, and
an upper surface of the common channel includes a protruded part protruding into the common channel in an area overlapping with the first communicating channel.

5. The liquid ejecting head according to claim 1, wherein
a channel resistance of a first individual channel included in the first individual channel row is equal to a channel resistance of a second individual channel included in the second individual channel row.

6. The liquid ejecting head according to claim 1, wherein
an inertance of a first individual channel included in the first individual channel row is equal to an inertance of a second individual channel included in the second individual channel row

7. The liquid ejecting head according to claim 5, wherein
the first individual channel includes a first connecting channel connecting the first pressure chamber and the common channel,
the second individual channel includes a second connecting channel connecting the second pressure chamber and the common channel, and
a length and a width of the first connecting channel are equal to a length and a width of the second connecting channel, respectively.

8. The liquid ejecting head according to claim 5, wherein
a third pressure chamber and a fourth pressure chamber overlap in the second direction, the third pressure chamber being included in a third individual channel row among the plurality of individual channel rows and the fourth pressure chamber being included in a fourth individual channel row adjacent to the third individual channel row among the plurality of individual channel rows,
a third nozzle included in the third individual channel row and a fourth nozzle included in the fourth individual channel row are located on the other side in the second direction with respect to the common channel in the second direction,
the third nozzle is located closer to the common channel than the fourth nozzle is in the second direction, and overlaps with the fourth pressure chamber in the up-down direction,
a channel configuration of the first individual channel is equal to a channel configuration of a third individual channel included in the third individual channel row, and
a channel configuration of the second individual channel is equal to a channel configuration of a fourth individual channel included in the fourth individual channel row.

9. The liquid ejecting head according to claim 5, wherein
the first individual channel includes a first up-down channel extending from the first nozzle in the up-down direction, and a first communicating channel communicating with the first pressure chamber and the first up-down channel,
a second individual channel includes a second up-down channel communicating with the second pressure chamber and the second nozzle, extending from the second nozzle in the up-down direction, and having a length in the up-down direction longer than a length in the up-down direction of the first up-down channel, and
the first communicating channel has a part extending in a fourth direction orthogonal to the up-down direction.

10. The liquid ejecting head according to claim 1, wherein
a first individual channel included in the first individual channel row includes a first up-down channel extending from the first nozzle in the up-down direction, and a first communicating channel communicating with the first pressure chamber and the first up-down channel,
a second individual channel included in the second individual channel row includes a second up-down channel communicating with the second pressure chamber and the second nozzle, extending from the second nozzle in the up-down direction, and having a length in the up-down direction longer than a length in the up-down direction of the first up-down channel,
the first communicating channel has a channel width smaller than a channel width of the first up-down channel, and
an upper part of the second up-down channel has a channel width smaller than a channel width of a remaining part, of the second up-down channel, other than the upper part.

11. The liquid ejecting head according to claim 1, wherein
a first individual channel included in the first individual channel row includes a first connecting channel connecting the first pressure chamber and the common channel,
a second individual channel included in the second individual channel row includes a second connecting channel connecting the second pressure chamber and the common channel, and
a connecting position at which the first connecting channel connects to the common channel and a connecting position at which the second connecting channel connects to the common channel are separated in the second direction.

12. The liquid ejecting head according to claim 1, wherein
a first individual channel included in the first individual channel row includes a first up-down channel extending from the first nozzle in the up-down direction, and a first communicating channel communicating with the first pressure chamber and the first up-down channel,
a second individual channel included in the second individual channel row includes a second connecting channel connecting the second pressure chamber and the common channel,
the first communicating channel has a first extending part extending in a fourth direction orthogonal to the up-down direction,
the second connecting channel has a second extending part extending in a fifth direction orthogonal to the up-down direction, and
the first extending part and the second extending part are located at mutually different heights.

13. The liquid ejecting head according to claim 1, wherein
a third pressure chamber and a fourth pressure chamber overlap in the second direction, the third pressure chamber being included in a third individual channel row among the plurality of individual channel rows and the fourth pressure chamber being included in a fourth individual channel row adjacent to the third individual channel row among the plurality of individual channel rows,
a third nozzle included in the third individual channel row and a fourth nozzle included in the fourth individual channel row are located on the other side in the second direction with respect to the common channel,
the third nozzle is located closer to the common channel than the fourth nozzle is in the second direction, and overlaps with the fourth pressure chamber in the up-down direction,
a first individual channel included in the first individual channel row includes a first connecting channel connecting the first pressure chamber and the common channel,
a third individual channel included in the third individual channel row includes a third connecting channel connecting the third pressure chamber and the common channel,
the first connecting channel has a third extending part extending in a sixth direction orthogonal to the up-down direction, and
the third connecting channel has a fourth extending part located side by side with the third extending part in the first direction and extending in the sixth direction.

14. The liquid ejecting head according to claim 1, wherein
the plurality of individual channels have a same channel shape.

15. The liquid ejecting head according to claim 14, wherein
the first nozzle is located closer to the common channel than the second nozzle is in the second direction, and overlaps with the second pressure chamber in the up-down direction orthogonal to the first direction and the second direction.

16. The liquid ejecting head according to claim 15, wherein
the channel member includes: another common channel which extends in the first direction and is disposed side by side with the common channel in the second direction, and a plurality of individual channels each including a nozzle and a pressure chamber communicating with the nozzle, each of the plurality of individual channels communicating with the another common channel,
a plurality of individual channel rows each including the plurality of individual channels communicating with the another common channel and aligned in the first direction are disposed side by side in the second direction,
a third pressure chamber and fourth pressure chamber overlap in the second direction, the third pressure chamber being included in a third individual channel row among the plurality of individual channel rows communicating with the another common channel and the fourth pressure chamber being included in a fourth individual channel row adjacent to the third individual channel row among the plurality of individual channel rows,
a third nozzle included in the third individual channel row and a fourth nozzle included in the fourth individual channel row are located on the other side in the second direction with respect to the another common channel, and are located between the common channel and the another common channel,
all of the plurality of individual channels communicating with the another common channel have a same channel shape,
the third nozzle is located closer to the another common channel than the fourth nozzle is in the second direction, and overlaps with the fourth pressure chamber in the up-down direction, and
the second nozzle overlaps with the fourth pressure chamber in the up-down direction, and the fourth nozzle overlaps with the second pressure chamber in the up-down direction.

17. The liquid ejecting head according to claim 16, wherein
each of the plurality of individual channels includes an up-down channel extending from the nozzle in the up-down direction, and a communicating channel communicating with the pressure chamber and the up-down channel,
each of the communicating channel included in the second individual channel row and the communicating channel included in the fourth individual channel row has a bent shape in a plane orthogonal to the up-down direction, and has a first part having one end connected to the pressure chamber corresponding thereto, and a second part having one end connected to the other end of the first part and the other end connected to the up-down channel, and
the second part of the communicating channel included in the second individual channel row and the second part of the communicating channel included in the fourth individual channel row overlap each other in the first direction and are separated from each other in the first direction.

18. The liquid ejecting head according to claim 15, wherein
each of the plurality of individual channels includes an up-down channel extending from the nozzle in the up-down direction, and a communicating channel communicating with the pressure chamber and the up-down channel, and
the communicating channel has a part of which cross-sectional area decreases in a stepped manner further downward from the pressure chamber.

19. The liquid ejecting head according to claim 15, wherein
each of the plurality of individual channels includes an up-down channel extending from the nozzle in the up-down direction, a communicating channel communicating with the pressure chamber and the up-down channel, and a connecting channel connecting the pressure chamber and the common channel,
the communicating channel has a first extending part extending in a third direction orthogonal to the up-down direction,
the connecting channel has a second extending part extending in a fourth direction orthogonal to the up-down direction, and
the first extending part and the second extending part are located at mutually different heights.

20. The liquid ejecting head according to claim 14, wherein
the channel member is constructed of a plurality of stacked plates.

21. The liquid ejecting head according to claim 14, wherein
a plurality of pressure chambers which includes the pressure chamber and each of which is included in one of the plurality of individual channels are open in a surface of the channel member, and
the liquid ejecting head further comprising an actuator member disposed on the surface and having a plurality of actuator parts each overlapping with one of the plurality of pressure chambers in the up-down direction.

22. The liquid ejecting head according to claim 16, wherein
all of a plurality of nozzles which includes the nozzle and each of which is included in the plurality of individual channels communicating with the another channel member are located while being shifted from one another in the first direction.

23. The liquid ejecting head according to claim 22, wherein
in a plane orthogonal to the up-down direction, one nozzle or two nozzles among the first nozzle to the fourth nozzles is or are not located on a straight line passing through two nozzles, among the first to fourth nozzles, which are adjacent in the second direction and other than the one nozzle or the two nozzles.

24. The liquid ejecting head according to claim 14, wherein
a first individual channel included in the first individual channel row includes a first connecting channel connecting the first pressure chamber and the common channel,
a second individual channel included in the second individual channel row includes a second connecting channel connecting the second pressure chamber and the common channel, and
a connecting position at which the first connecting channel connects to the common channel and a connecting position at which the second connecting channel connects to the common channel are separated in the second direction.
